(19) United States
(12) Patent Application Publication
(10) Pub. No.: US 2019/0234480 A1
(43) Pub. Date: Aug. 1, 2019

(54) MAGNETIC SUSPENSION SHOCK ABSORBER

(71) Applicant: SUHDER IND CO., LTD., Miaoli County (TW)

(72) Inventors: Der-Guey BU, Miaoli County (TW); Jia-Qing LIU, Miaoli County (TW)

(21) Appl. No.: 15/884,623

(22) Filed: Jan. 31, 2018

(51) Int. Cl. F16F 13/00; F16F 15/02; F16F 15/03

(52) U.S. Cl. CPC F16F 13/005; F16F 15/022; F16F 15/03; F16F 2230/10; F16F 2224/0241; F16F 2230/0023; F16F 2222/06

(57) ABSTRACT

A magnetic suspension shock absorber is composed of an outer telescopic cylinder, a shaft rod, an inner telescopic cylinder and two sets of magnetic suspension units. Each set of magnetic suspension unit contains two magnets, and the corresponding surfaces of two magnets of each magnetic suspension unit are the same magnetic polarity. The magnets of two sets of magnetic suspension units are respectively combined with the outer telescopic cylinder, the shaft rod and the inner telescopic cylinder. Thus, when the inner telescopic cylinder is impacted by external force, two magnets of one magnetic suspension unit will be close to each other and produce mutual repulsion, thus achieving buffering and shock absorbing effects.

### BACKGROUND OF THE INVENTION

### 1. Field of the Invention

This invention relates to a shock absorber, particularly to a magnetic suspension shock absorber.

### 2. Description of the Prior Art

Conventional shock absorbers include a spring type shock absorber and a pneumatic shock absorber. The spring type shock absorber is formed with less supporting force and hence limited in application occasions and further, after frequency of use attains to a certain extent, the spring type shock absorber will result in metal fatigue and lose efficacy. The pneumatic shock absorber needs to be filled with liquid nitrogen at low temperature and has the liquid nitrogen converted into high pressure gas at normal temperature and requires high precision in processing of cylinders and pistons, complicated in manufacturing and high in cost, and further the pneumatic shock absorber may cause danger under high temperature environments and after used for a long period, the pneumatic shock absorber may lead to leakage of high pressure gas because of ageing of the sealing members and make the shock absorber lose efficacy. Aside from foresaid two kinds of shock absorbers, there is a hydraulic shock absorber, which is driven by liquid and hence is comparatively complicated in structure. The hydraulic shock absorber is characterized by strong supporting force, but the hydraulic shock absorber is slow in movement and is not quite similar to foresaid two kinds of shock absorbers in application occasions. Having observed above-mentioned drawbacks, the inventor of this invention thinks that the conventional shock absorbers are necessary to be ameliorated and hence devises this invention.

### SUMMARY OF THE INVENTION

The objective of this invention is to offer a magnetic suspension shock absorber, which is simple in structure and has the same supporting force as that of a pneumatic shock absorber. Especially, requirements in processing precision of the magnetic suspension shock absorber are low, able to reduce manufacturing cost, and further the magnetic suspension shock absorber can be applied to different environments and prolong its service life.

The magnetic suspension shock absorber in the present invention contains an outer telescopic cylinder formed with an accommodating groove and having one end provided with an opening communicating with the accommodating groove and another end bored with an insert hole. A shaft rod has one end fixed with the insert hole of the outer telescopic cylinder and another end positioned in the accommodating groove and inserted through the opening and further provided thereon with a piston. An inner telescopic cylinder is combined with the shaft rod and slidably provided in the accommodating groove of the outer telescopic cylinder, formed with an accommodating groove in the interior and bored with an opening at one end facing the outer telescopic cylinder, the opening communicating with the accommodating groove and provided thereon with a fixing member. An elastic member is fitted around the shaft rod and located in the accommodating groove of the inner telescopic cylinder, having one end resisting against the fixing member. A first magnetic suspension unit contains a first magnet and a second magnet. The first magnet is received in the accommodating groove of the inner telescopic cylinder, and the second magnet horizontally corresponding to the first magnet is provided at the topside of the piston and has a central portion bored with an insert hole, letting one end of the shaft rod inserted through the piston and then inserted in the insert hole of the second magnet. The corresponding surfaces of the first magnet and the second magnet are the same magnetic polarity. A second magnetic suspension unit contains a third magnet and a fourth magnet. The third magnet is fixed at the underside of the piston, while the fourth magnet is disposed at another end of the elastic member. The third magnet and the fourth magnet have their central portions respectively bored with an insert hole for the shaft rod to be inserted therethrough and further, the corresponding surfaces of the third magnet and the fourth magnet are the same magnetic polarity.

The magnetic suspension shock absorber of this invention is to make use of the magnetic force of the magnets of the first magnetic suspension unit and the magnets of the second magnetic suspension unit to carry out buffering of external impact and further employ the elastic member to make the magnetic suspension shock absorber maintain a balance state. Moreover, air tightness and precision between the outer telescopic cylinder and the inner telescopic cylinder of the magnetic suspension shock absorber are not strictly demanded, thus decreasing manufacturing cost and enabling the magnetic suspension shock absorber to be applied to different environments.

### BRIEF DESCRIPTION OF DRAWINGS

This invention will be better understood by referring to the accompanying drawings, wherein:

FIG. 1 is a perspective view of a preferred embodiment of a magnetic suspension shock absorber in the present invention;

FIG. 2 is a cross-sectional view of the magnetic suspension shock absorber in the present invention, showing a state when the magnetic suspension shock absorber is not yet impacted by external force;

FIG. 3 is a partial magnified view of FIG. 2; and

FIG. 4 is a cross-sectional view of the magnetic suspension shock absorber in the present invention, showing a state when the magnetic suspension shock absorber is impacted by external force.

### DETAILED DESCRIPTION OF THE PREFERRED EMBODIMENT

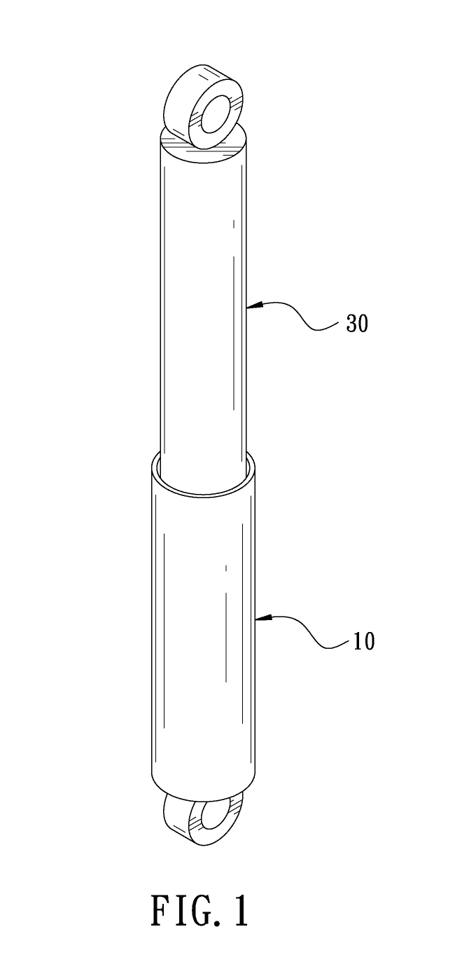

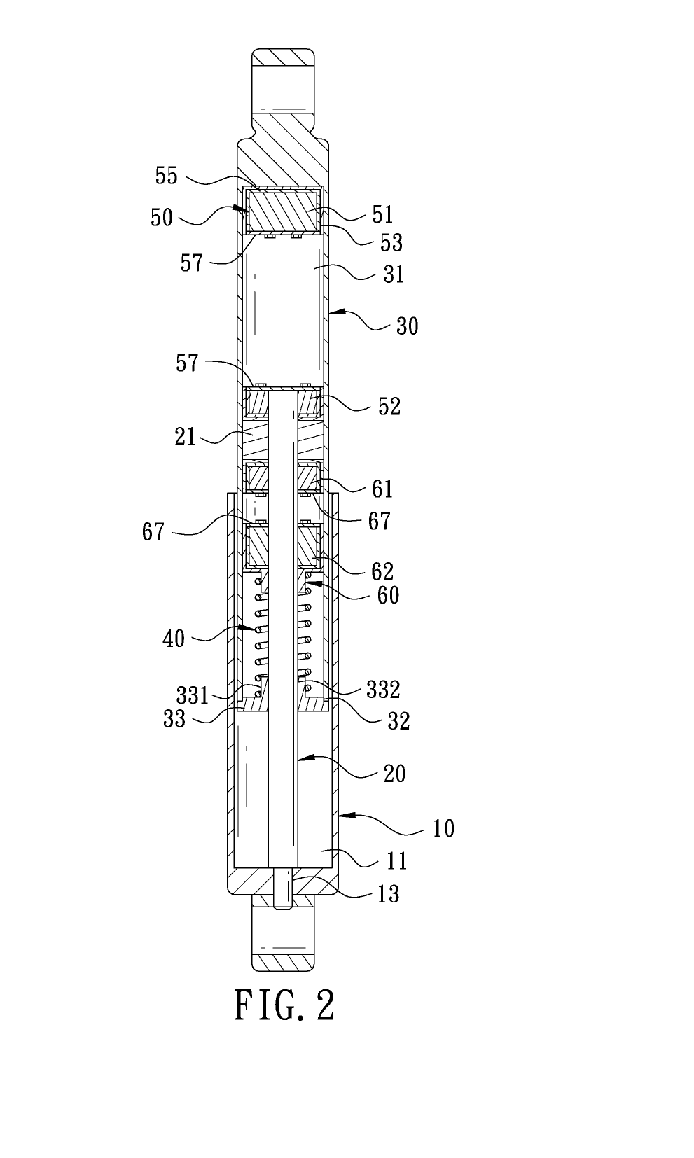

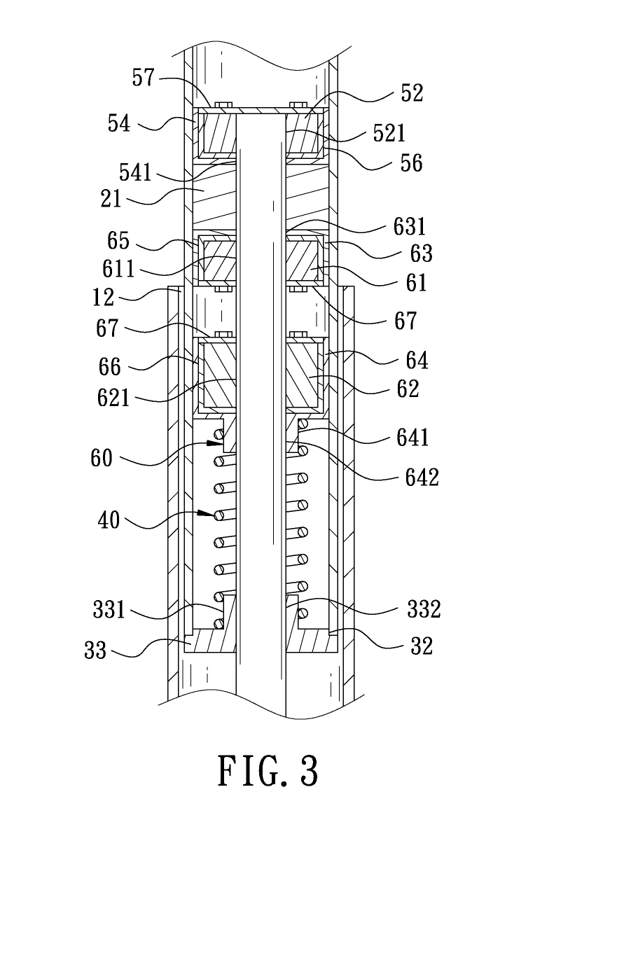

A preferred embodiment of a magnetic suspension shock absorber in the present invention, as shown in FIGS. 1-3, includes an outer telescopic cylinder 10, a shaft rod 20, an inner telescopic cylinder 30, an elastic member 40, a first magnetic suspension unit 50 and a second magnetic suspension unit 60 as main components combined together.

The outer telescopic cylinder 10 is hollow long tube-shaped, having its interior formed with an accommodating groove 11, and one end provided with an opening 12 communicating with the accommodating groove 11 and another end bored with an insert hole 13.

The shaft rod 20 has one end fixed in the insert hole 13 of the outer telescopic cylinder 10 and another end positioned in the accommodating groove 11 and inserted through the opening 12 and further provided thereon with a piston 21.

The inner telescopic cylinder 30 is combined with the shaft rod 20 and slidably fitted in the accommodating groove 11 of the outer telescopic cylinder 10. The inner telescopic cylinder 30 corresponding with the outer telescopic cylinder 10 is hollow long tube-shaped, formed with an accommodating groove 31 in the interior and provided with an opening 32 at one end facing the outer telescopic cylinder 10. The inner telescopic cylinder 30 further contains a fixing member 33 disposed at the lower end of the inner telescopic cylinder 30 and secured at the location of the opening 32. The fixing member 33 has a topside formed with an engage flange 331 and a central portion bored with a through hole 332 for the shaft rod 20 to be inserted therethrough.

The elastic member 40 is fitted around the shaft rod 20 and positioned in the accommodating groove 31 of the inner telescopic cylinder 30 and has one end resisting against the engage flange 331 of the fixing member 33. In this preferred embodiment, the elastic member 40 is a spring.

The first magnetic suspension unit 50 consists of a first magnet 51 and a second magnet 52. The first magnet 51 is received in the accommodating groove 31 of the inner telescopic cylinder 30, and the second magnet 52 horizontally corresponding to the first magnet 51 is mounted at the topside of the piston 21 and has a central portion bored with an insert hole 521, letting one end of the shaft rod 20 inserted through the piston 21 and then inserted in the insert hole 521 of the second magnet 52 and further, the corresponding surfaces of the first magnet 51 and the second magnet 52 are the same magnetic polarity. In addition, the first magnet 51 has its outer circumference covered with a first outer cover 53, and the second magnet 52 is covered with a second outer cover 54, which is bored with a through hole 541 for the shaft rod 20 to be inserted therthrough and fixed in the insert hole 521 of the second magnet 52. Moreover, a first protective casing 55 is disposed between the first magnet 51 and the first outer cover 53, and a second protective casing 56 is disposed between the second magnet 52 and the second outer cover 54. The first protective casing 55 and the second protective casing 56 are made of nylon fiber or glass fiber, able to protect the first magnet 51 and the second magnet 52. Furthermore, the corresponding surfaces of the first magnet 51 and the second magnet 52 are respectively fixed with an anti-impact pad 57, which has effects of protection and anti-impact for preventing the first magnet 51 and the second magnet 52 from being damaged when the inner telescopic cylinder 30 is stricken by external force.

The second magnet suspension unit 60 contains a third magnet 61 and a fourth magnet 62. The third magnet 61 is provided at the underside of the piston 21, while the fourth magnet 62 is provided at another end of elastic member 40, and the third magnet 61 and the fourth magnet 62 have their central portions respectively bored with an insert hole 611, 621 for the shaft rod 20 to be inserted therethrough and further, The corresponding surfaces of the third magnet 61 and the fourth magnet 62 are the same magnetic polarity. In addition, the third magnet 61 has its outer circumference covered with a third outer cover 63, and the fourth magnet 62 is covered with a fourth cover 64. The third outer cover 63 is bored with a through hole 631 corresponding to the insert hole 611 of the third magnet 61, and the fourth outer cover 64 is provided with an annular flange 641 at the underside and bored with a through hole 642 corresponding to the insert hole 621 of the fourth magnet 62. Further, a third protective casing 65 is disposed between the third magnet 61 and the third outer cover 63, and a fourth protective casing 66 is disposed between the fourth magnet 62 and the fourth outer cover 64. The third protective casing 65 and the fourth protective casing 66 are made of nylon fiber or glass fiber, able to protect the third magnet 61 and the fourth magnet 62. Furthermore, the third magnet 61 and the fourth magnet 62 have their corresponding surfaces respectively provided with an anti-impact pad 67 having efficacy of protection and impact prevention for avoiding both the third magnet 61 and the fourth magnet 62 being damaged.

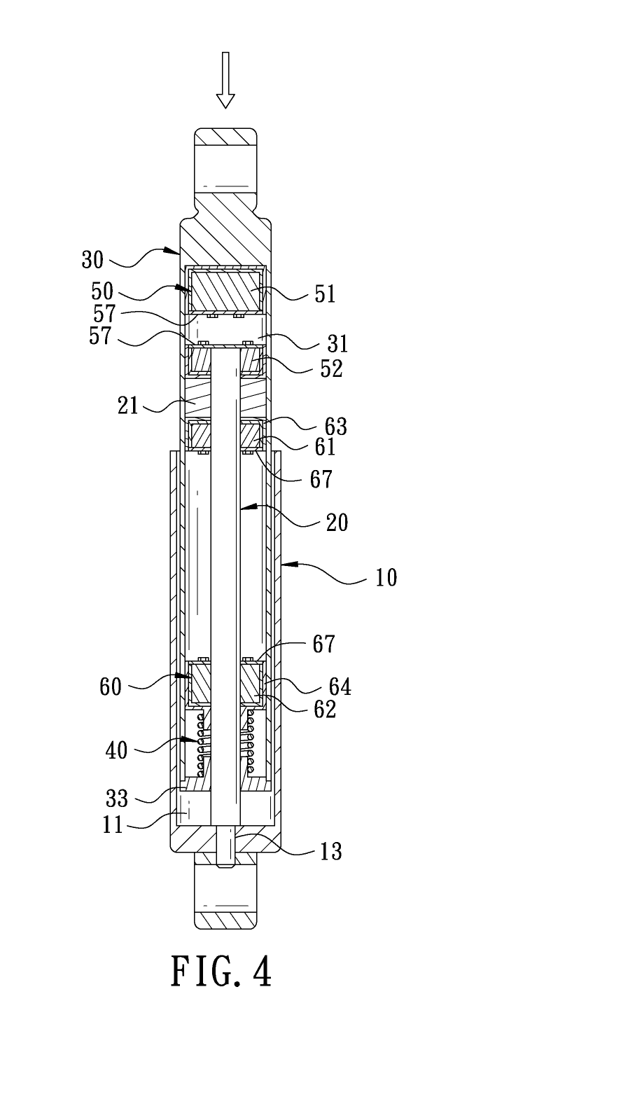

In operating, referring to FIG. 4, when the inner telescopic cylinder 30 is impacted by external force, the inner telescopic cylinder 30 will axially slide toward the outer telescopic cylinder 10, letting the first magnet 51 approach the second magnet 52, and since the corresponding surfaces of the first magnet 51 and the second magnet 52 are the same magnetic polarity; therefore, the first magnet 51 and the second magnet 52 will repel each other and hence the outer telescopic cylinder 10 and the piston 21 will not bump against each other, thus attaining buffering effect. When external force vanishes, the first magnet 51 and the second magnet 52 will stay away from each other and meanwhile, the third magnet 61 and the fourth magnet 62 will be close to each other. Since the corresponding surfaces of the third magnet 61 and the fourth magnet 62 are the same magnetic polarity; therefore, the third magnet 61 and the fourth magnet 62 will produce mutual repulsion and in the meantime, the elastic force of the elastic member 40 will function to push against the fourth magnet 62, letting the fourth magnet 62 draw near to the third magnet 61 for restoring an unstressed state, thus achieving buffering and shock-absorbing effects.

One thing worth mentioning is that the magnetic power of the first magnetic suspension unit 50 is larger than that of the second magnetic suspension unit 60 and the elasticity of the elastic member 40 is able to make the first magnetic suspension unit 50 and the second magnetic suspension unit 60 maintain an equilibrium state when the inner telescopic cylinder 30 is not impacted by external force.

Another thing worthy of mentioning is that air tightness and precision between the outer telescopic cylinder 10 and the inner telescopic cylinder 30 are not strictly demanded, thus lowering manufacturing cost and enabling the magnetic suspension shock absorber to be applied to different environments.

While the preferred embodiment of this invention has been described above, it will be recognized and understood that various modifications may be made therein and the appended claims are intended to cover all such modifications that may fall within the spirit and scope of the invention.

What is claimed is:

1. A magnetic suspension shock absorber comprising:
an outer telescopic cylinder formed with an accommodating groove, said outer telescopic cylinder having one end provided with an opening, said opening communicating with said accommodating groove, said outer telescopic cylinder having another end bored with an insert hole;
a shaft rod having one end fixed with said insert hole of said outer telescopic cylinder, said shaft rod having another end received in said accommodating groove and inserted through said opening and further provided thereon with a piston;
an inner telescopic cylinder combined with said shaft rod and slidably positioned in said accommodating groove of said outer telescopic cylinder, said inner telescopic cylinder formed with an accommodating groove in the interior, said inner telescopic cylinder provided with an opening at one end facing said outer telescopic cylinder, said opening communicating with said accommodating groove, said opening disposed thereon with a fixing member;
an elastic member fitted around said shaft rod and positioned in said accommodating groove of said inner telescopic cylinder, said elastic member having one end resisting against said fixing member;
a first magnetic suspension unit comprising a first magnet and a second magnet, said first magnet received in said accommodating groove of said inner telescopic cylinder, said second magnet horizontally corresponding to said first magnet and provided at a topside of said piston, said second magnet having a central portion bored with an insert hole, said shaft rod having one end inserted through said piston and then inserted in said insert hole of said second magnet, corresponding surfaces of said first magnet and said second magnet being the same magnetic polarity; and
a second magnetic suspension unit comprising a third magnet and a fourth magnet, said third magnet disposed under said piston, said fourth magnet disposed at another end of said elastic member, both said third magnet and said fourth magnet having their central portions respectively bored with an insert hole for said shaft rod to be inserted therethrough, corresponding surfaces of said third magnet and said fourth magnet being the same magnetic polarity.

2. The magnetic suspension shock absorber as claimed in claim 1, wherein said first magnet and said second magnet are respectively covered with a first outer cover and a second outer cover, said second outer cover bored with a through hole corresponding to said insert hole of said second magnet for said shaft rod to inserted therethrough, said third magnet and said fourth magnet respectively covered with a third outer cover and a fourth outer cover, said third outer cover and said fourth outer cover respectively bored with a through hole corresponding to said insert hole of said third magnet and said fourth magnet for said shaft rod to be inserted therethrough.

3. The magnetic suspension shock absorber as claimed in claim 1, wherein said fourth outer cover has an underside provided with an annular flange, and said elastic member has one end fitted around an outer circumference of said annular flange, said fixing member having an upper central portion provided with an engage flange, said elastic member having another end fitted around said engaged flange of said fixing member.

4. The magnetic suspension shock absorber as claimed in claim 2, wherein said first magnet, said second magnet, said third magnet and said fourth magnet have their outer circumferences respectively covered with a first protective casing, a second protective casing, a third protective casing and a fourth protective casing, said first protective casing, said second protective casing, said third protective casing and said fourth protective casing being made of nylon fiber or glass fiber.

5. The magnetic suspension shock absorber as claimed in claim 1, wherein said fixing member is secured at a lower end of said inner telescopic cylinder, said fixing member having a topside formed with an engage flange, said fixing member having a central portion bored with a through hole for said shaft rod to be inserted therethrough, said elastic member having one end pressing against said engage flange.

6. The magnetic suspension shock absorber as claimed in claim 1, wherein corresponding surfaces of said first magnet and said second magnet and corresponding surfaces of said third magnet and said fourth magnet are respectively provided with an anti-impact pad.

7. The magnetic suspension shock absorber as claimed in claim 1, wherein said elastic member is a spring.

8. The magnetic suspension shock absorber as claimed in claim 1, wherein magnetic force of said first magnetic suspension unit is larger than that of said second magnetic suspension unit.

9. The magnetic suspension shock absorber as claimed in claim 1, wherein said outer telescopic cylinder is hollow long tube-shaped, and said inner telescopic cylinder corresponding with said outer telescopic cylinder is hollow long tube-shaped.
